(19) United States
(12) Patent Application Publication
(10) Pub. No.: US 2013/0255994 A1
(43) Pub. Date: Oct. 3, 2013

(54) CABLE POSITIONING MECHANISM AND ELECTRONIC DEVICE HAVING THE SAME

(71) Applicant: XIAO-HUI ZHOU, Shenzhen City (CN)

(72) Inventor: XIAO-HUI ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/563,760

(22) Filed: Aug. 1, 2012

(30) Foreign Application Priority Data
Mar. 30, 2012 (CN) 201210089741.2

(51) Int. Cl. H01B 17/14

(52) U.S. Cl. 174/135

(57) ABSTRACT

A cable positioning mechanism configured to hold at least one cable in position includes a main body attached to the bottom surface of the electronic device. The main body includes a first edge and a second edge intersecting with each other. A bent portion projects from the first edge and is bent toward the bottom surface. A supporting portion projects from a distal end of the bent portion. A block member projects from the second edge. The block member, the bent portion, and the supporting portion cooperatively form a slot to hold the cable therein.

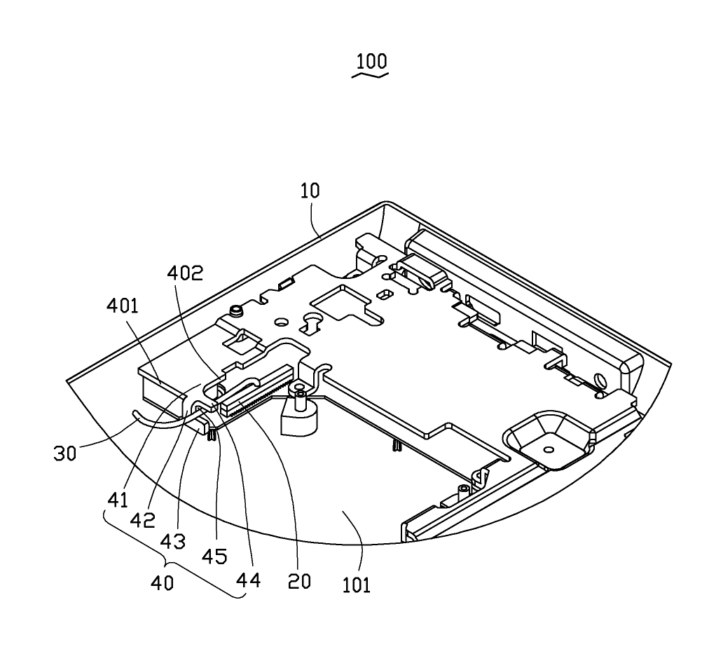

### BACKGROUND

1. Technical Field

The present disclosure relates to positioning mechanisms, and particularly, to a cable positioning mechanism and an electronic device having the cable positioning mechanism.

2. Description of Related Art

Many electronic devices include a variety of cables for electrically connecting different electronic components together. However, during assembly, an external force may be applied to the cables by accident and then directly apply to a connecting point between the cable and the electronic component, which may cause the cable to be detached from the electronic component.

Therefore, what is needed is a means to solve the problem described above.

### BRIEF DESCRIPTION OF THE DRAWINGS

Many aspects of the present disclosure should be better understood with reference to the following drawing. The units in the drawings are not necessarily drawn to scale, the emphasis instead being placed upon clearly illustrating the principles of the present disclosure.

The drawing is a partial isometric view of an electronic device using a cable positioning mechanism in an exemplary embodiment, in which an upper cover is omitted.

### DETAILED DESCRIPTION

The disclosure is illustrated by way of example and not by way of limitation in the figures of the accompanying drawing in which like references indicate similar elements. It should be noted that references to “an” or “one” embodiment in this disclosure are not necessary to the same embodiment, and such references mean at least one.

The drawing is an exemplary embodiment of an electronic device 100 with an upper cover omitted for clarity. The electronic device 100 includes a bottom cover 10 defining a receiving space 100 for receiving at least one electronic component 20, at least one cable 30 including one end connected to the electronic component 20, and a cable positioning mechanism 40 for holding the cable 30. The cable positioning mechanism 40 is arranged on an inner surface of the bottom cover 10.

The cable positioning mechanism 40 includes a main body 41. The main body 41 is substantially parallel to the inner surface of the bottom cover 10. In an embodiment, the main body 41 is a heat dispersing plate. The main body 41 includes a first edge 401 and a second edge 402 connected with the first edge 401. A bent portion 42 projects from the first edge 401 and is bent toward a bottom surface of the bottom cover 10. A supporting portion 43 projects from the distal end of the bent portion 42 and is substantially parallel to the first edge 401. The supporting portion 43 and the bent portion 42 are angled with respect to each other. A blocking member 44 projects from the second edge 402 and is substantially coplanar with the main body 41. The blocking member 44 is adjacent to the bent portion 42. The blocking member 44, the bent portion 42, and the supporting portion 43 cooperatively form a slot 45 for receiving the cable 30 therein to limit movement of the cable 30.

The size of the slot 45 may be varied according to the number of the cables 30 that need to be received in the slot 45. For example, the distance between the supporting portion 43 and the blocking member 44, and the length of the bent portion 42 can be increased when the space 45 is intended to receive more cables 30.

During assembly, the first step is to guide the cable 30 into the slot 45, then the end of the cable 30 away from the electronic component 20 extended away from the blocking member 44, such that movement of the cable 30 perpendicular to the bottom cover 10 can be restricted by the blocking member 44 and the supporting portion 43. Furthermore, because the extension direction of the cable 30 is changed in the bent portion 42, external force applied to the end of the cable 30 away from the electronic component 20 will not directly act on the connection portion between the cable 30 and the electronic component 20, thus the cable may not be easily detached from the electronic component 20.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A cable positioning mechanism for being attached to a bottom surface of an electronic device and configured to hold at least one cable in position, the cable positioning mechanism comprising:
a main body attached to the bottom surface of the electronic device, the main body comprising a first edge and a second edge connecting with each other;
a bent portion projecting from the first edge and being bent toward the bottom surface;
a supporting portion projecting from an distal end of the bent portion; and
a blocking member projecting from the second edge;
wherein the block member, the bent portion and the supporting portion cooperatively form a slot to hold the at least one cable therein.

2. The cable positioning mechanism as described in claim 1, wherein the main body is a heat dispersing plate.

3. The cable positioning mechanism as described in claim 1, wherein the supporting portion is substantially parallel to the first edge, and the supporting portion and the bent portion are angled with respect to each other.

4. The cable positioning mechanism as described in claim 1, wherein the blocking member is substantially coplanar with the main body, and is adjacent to the bent portion.

5. An electronic device, comprising:
a bottom cover defining a receiving space; and
a cable positioning mechanism received in the receiving space and configured to hold at least one cable in position, the cable positioning mechanism comprising:
a main body attached to the bottom surface of the electronic device, the main body comprising a first edge and a second edge intersecting with each other;
a bent portion projecting from the first edge and being bent toward the bottom surface;
a supporting portion projecting from an distal end of the bent portion; and
a blocking member projecting from the second edge;
wherein the block member, the bent portion and the supporting portion cooperatively form a slot to hold the at least one cable therein.

6. The electronic device as described in claim 5, wherein the main body is a heat dispersing plate.

7. The electronic device as described in claim 5, wherein the supporting portion is substantially parallel to the first edge, and the supporting portion and the bent portion are angled with respect to each other.

8. The electronic device as described in claim 5, wherein the blocking member is substantially coplanar with the main body, and is adjacent to the bent portion.
